(19) United States
(12) Patent Application Publication
(10) Pub. No.: US 2007/0294566 A1
(43) Pub. Date: Dec. 20, 2007

(54) Restoring Computing Devices Using Network Boot

(75) Inventor: Sergey Solyanik, Seattle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/421,377

(22) Filed: May 31, 2006

(51) Int. Cl. G06F 11/00

(52) U.S. Cl. 714/6

(57) ABSTRACT

A method of restoring information comprising initializing a computer from a networked device, selecting a backup image that includes user generated information, disposed on the networked device, and reinstalling the backup image from the networked device to the computer.

### TECHNICAL FIELD

This description relates generally to backing up computer systems and more specifically to restoring computer systems from a network.

### BACKGROUND

Computers sometimes lose data, often due to disk errors or “crashes”. Backup solutions are crafted to prevent loss of information, including the operating system (OS), configuration information, and user-generated files such as documents, pictures, and the like. To restore a personal computer's (PC's) operating system, it is necessary to boot from a device, such as a hard drive, CD-ROM, or other device other than the system disk, since the operating system cannot function while the system disk is being overwritten by the process that restores the disk. For this reason, a typical backup solution provides a bootable CD with an alternative operating system (herein called the restore OS), which is used to run the application that restores the PC. One skilled in the art would recognize that other examples of backups may include copies of files in the same format they were stored on the original client, or in various other formats recognized by the backup and restore applications.

Backup storage may be provided by a server computer to a client computer coupled to it. Such uses of a network to facilitate backup is typically enabled by the increased prevalence of high capacity storage present in server computers. Such server computers may often be found in home, commercial, and enterprise settings.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The present example provides a way for a server to provide a backup image to restore to a client computer initialized via a network boot. This allows applications and user data to be restored in addition to an operating system when the client computer is booted from a network. This example uses an “image” type of backup, but one skilled in the art would realize that any format could be used for the backup files.

Many of the attendant features may be more readily appreciated as the same becomes better understood by reference to the following detailed description considered in connection with the accompanying drawings.

### DESCRIPTION OF THE DRAWINGS

The present description may be better understood from the following detailed description read in light of the accompanying drawings, wherein:

FIG. 1 is a block diagram of a conventional computer network capable of initializing computers using conventional operating system (“OS”) installation files.

FIG. 2 is a block diagram of an example of a networked computing system operating environment for restoring backup images to computers via a procedure for restoring backup images.

FIG. 3 is a block diagram of a conventional computer network of FIG. 1, but showing additional detail of the local area network as it pertains to initializing computers using conventional operating system (“OS”) installation files

FIG. 4 is a block diagram of an example of a computer network of FIG. 2, but showing additional detail of the local area network as it pertains to restoring backup images to computers via a network boot.

FIG. 5 is a flowchart showing a procedure for restoring backup images where the backup image to restore is either selected automatically or via a user interface.

FIG. 6 is a flowchart showing the process for selecting a backup image to restore automatically.

FIG. 7 is a flowchart showing the process of choosing a backup image to restore via a user interface.

FIG. 8 is a block diagram which illustrates an exemplary computing environment in which the process for restoring a backup image may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

The examples below describe a process and a system for a server to provide a restore OS via a network boot to enable the restoration of a backup to a client computer. Although the present examples are described and illustrated herein as being implemented in client PCs and a server with a hard drive system, the system described is provided as an example and not a limitation. As those skilled in the art may appreciate, the present examples are suitable for application in a variety of different types of variety of different types of computing processor in computer restoration systems.

The present example provides a way for a server to provide a restore OS via a network boot to enable the restoration of a backup to a client computer. This allows an operating system, applications, and user data to be restored when the client computer is booted from a network. Before describing the present example a conventional network will first be described.

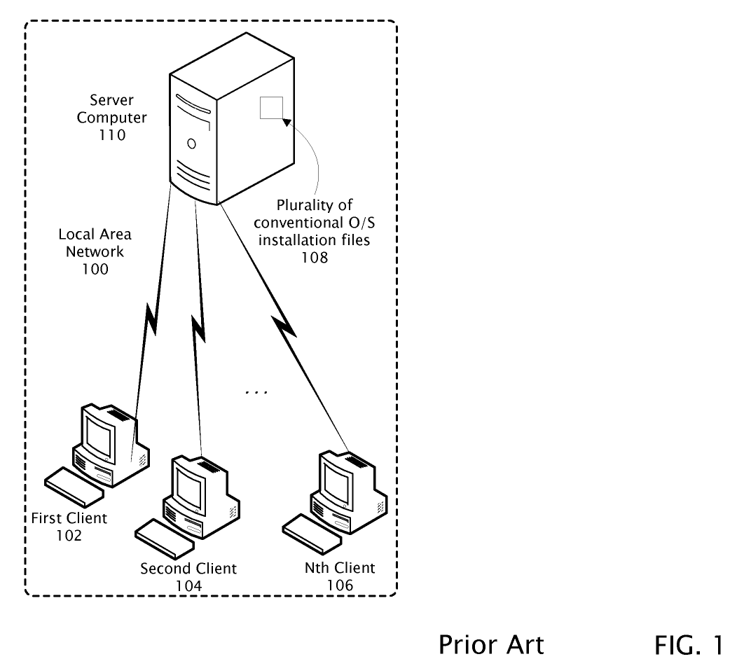

FIG. 1 is a block diagram of a conventional computer network capable of initializing computers using conventional operating system (“OS”) installation files 108. Such a system may not provide a complete backup of later changes to the OS and user settings. Local area network 100 consists of first server computer 110, first client computer 102, second client computer 104, and nth client computer 106. Any number of client computers, as well as various hubs, switches, and other network devices may be utilized in such a conventional network.

A person skilled in the art would recognize that the local area network 100 may connect to any number of other local area networks, and that such connections could be made a number of ways including, but not limited to, the internet, an intranet, satellite connections, or wireless connections, or any combination of the possible connections. The local area network 100 may also stand alone, and not be connected to any other local area networks or wide area networks. Those skilled in the art would also realize that a number of other components may be present such as routers, switches and the like may also be present to facilitate networking.

Server computer 110 is conventionally constructed and includes a mass storage device 108 having a plurality of conventional operating system installation files disposed on it. Such a mass storage system can include individual hard drives or networked hard drives such as RAID drives or the like.

Client computers 102, 104, and 106 are conventionally constructed and may be initialized by conventional methods. For example the client computers may be conventional PCs, computers, processors, microcontrollers or the like. Next an example of a network capable of for restoring backup images to computers via a network boot will be described.

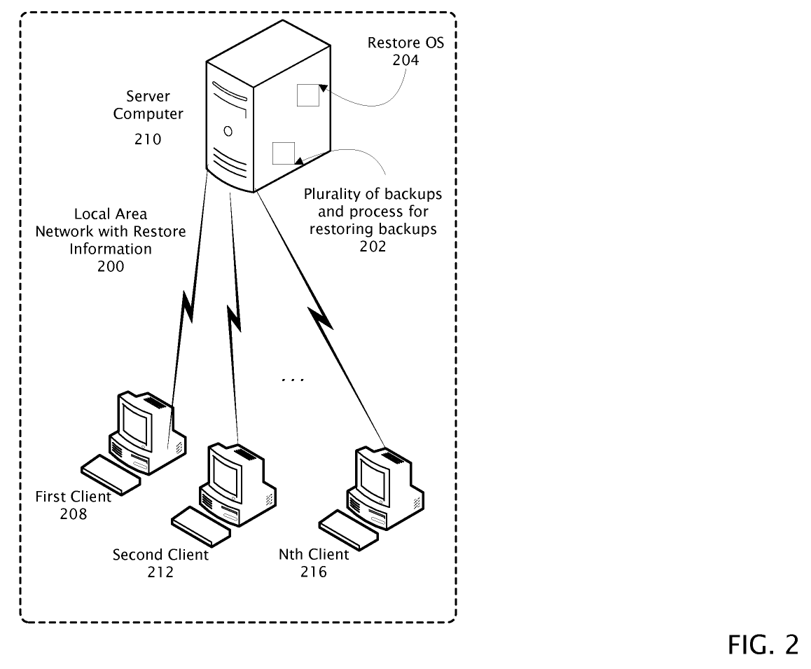

FIG. 2 is a block diagram of an example of a networked computing system operating environment for restoring backup images 202 to computers via a network boot. Local area network 200 consists of server computer 210, client computers 208, 212, and 216. A person skilled in the art would recognize that a local area network could also include a plurality of servers, hubs, switches, wireless access points, and other network devices, as well as any number of server and client computers.

Server computer 210 includes a mass storage device 202 having a plurality of backup images disposed on it. A person skilled in the art may recognize that there could be multiple restore images for any one client, and that there may be clients for which there is no corresponding backup image. Server computer 210 also has restore OS 204 disposed on mass storage device 202. Restore OS 204 is an operating system that may be booted via the network from a plurality of client computers.

Having a server containing backup images for client computers may allow a client computer to use a boot from network option, and then restore a backup image rather than doing a clean install of an operating system. This would allow the restoration of user files, application files and settings, and any other types of information that had been on the client computer at the time the backup was taken in addition to installing the operating system.

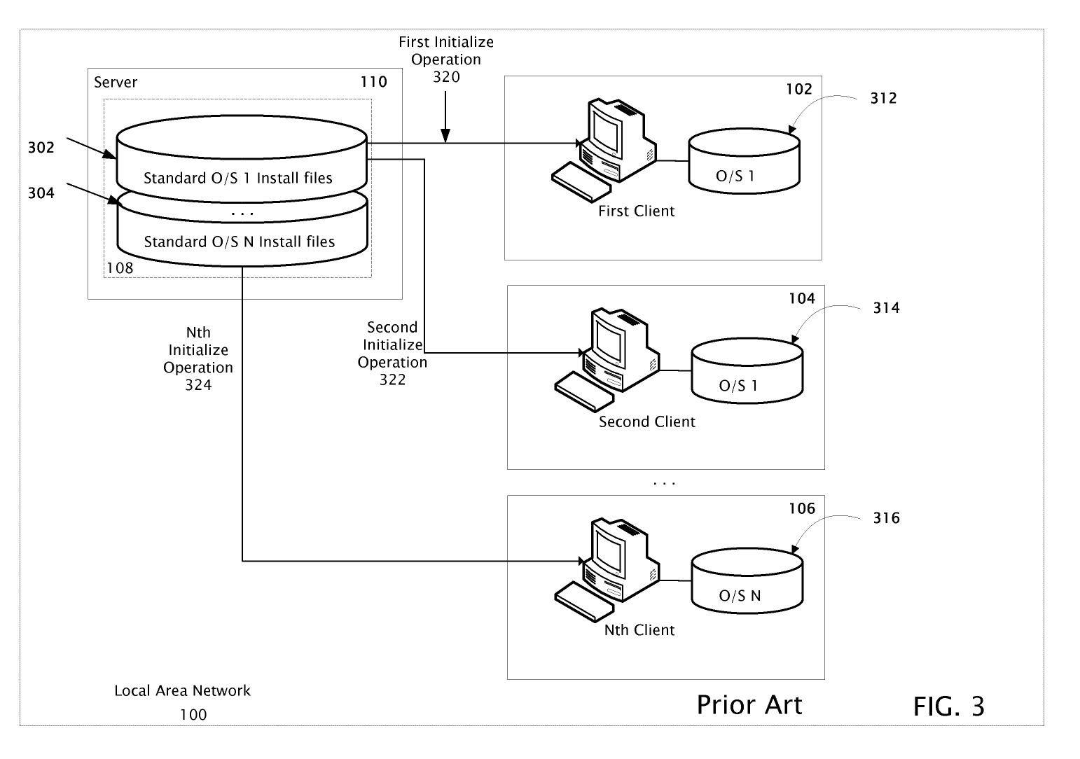

FIG. 3 is a block diagram of a conventional computer network 100 of FIG. 1, but showing additional detail of the first local area network 100 as it pertains to initializing computers 102, 104, 106 using conventional operating system (“OS”) installation files 302, 304. This process could be used to re-initialize client computers in the event, for example, that a client computer has a hard drive failure, or if a virus infected all of the clients on a network. This type of initialization system may provide a capability to initialize the client computers with a clean install of an operating system, but with the loss of any client files, applications, and application settings and data that may have changed since the client computer last had a clean install.

A network server computer 110 typically has a plurality of conventional operating system installation files, 302 and 304. First client computer 102 has a mass storage system 312, which contains an operating system, application, and data files. Because of a problem with the mass storage device, a user on computer 102 may desire to re-initialize the computer by obtaining the standard operating system 1 installation files 302 from Server 110 by performing a first initialize operation or transform 320. An initialization operation may be the clean installation of an operating system, replacing what is currently on computer 102. This may be initiated via a network boot, allowing a setup process to be run on computer 102 to begin a fresh operating system installation. This may cause the operating system, application, and data files on computer 102 to be replaced with the standard operating system 1 installation files 302, resulting in application and data file loss.

Similarly, a user at the second client computer 104 may re-initialize the local mass storage device 314 with the same operating system image 302, resulting in the loss of application and data files on 314. Server 110 may contain more than one set of standard operating system installation files; for example standard operating system 1 installation files 302 may contain a client operating system, standard operating system 2 installation files 304 may contain a server operating system.

Thus a user at Nth client computer 316 may use initialize operation 324 to replace the operating system, application, and data files on mass storage device 318 with standard operating system installation files 304, which may result in the loss of application and data files formerly on mass storage device 316. A person skilled in the art may recognize that first server computer 110 may have any number of standard operating system installation files disposed on a mass storage device 108, and that the mass storage device may include, an internal hard drive, an external hard drive, CD or DVD drives, USB devices, or other external or internal computer readable media.

This type of operating system initialization can allow loss of application data, loss of user settings, and a loss of other information that may have been added or changed after the operating system was first installed on the client computer. The example described below may provide a more extensive backup system.

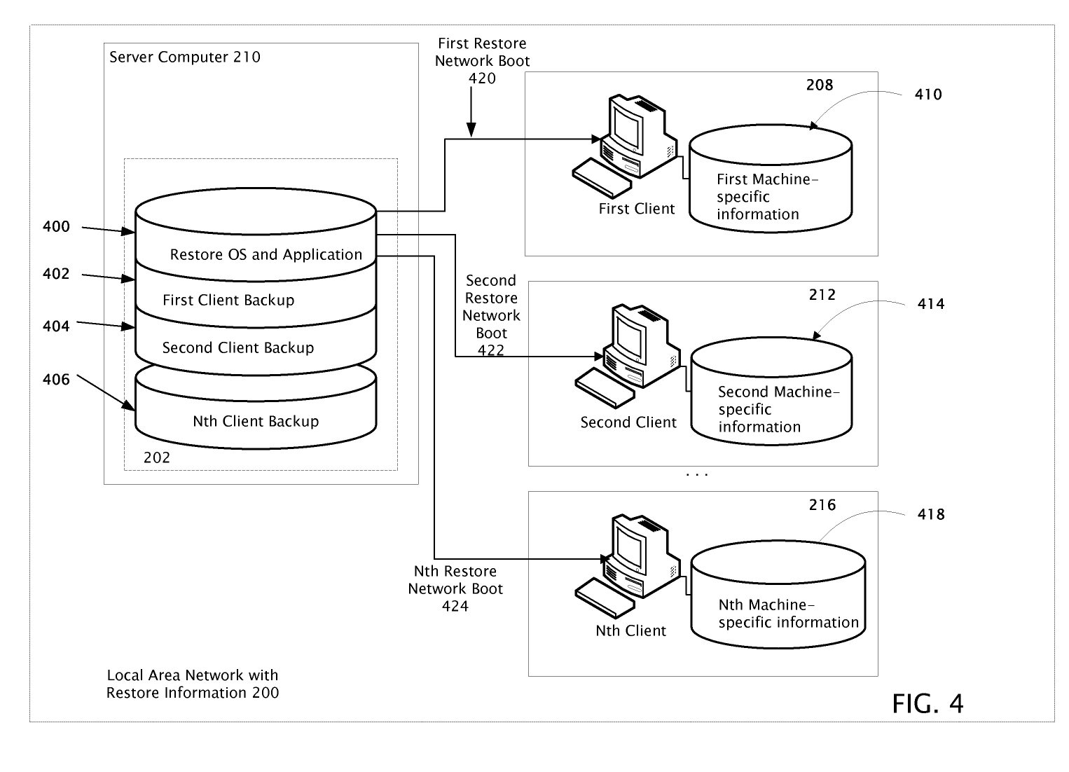

FIG. 4 is a block diagram of an example of a computer network similar to FIG. 2, but showing additional detail of the first local area network as it pertains to restoring backups to computers via a network boot that may allow a more complete back up to be restored. This type of initialization system can provide a partial or comprehensive restore of a hard drive. This process could be used to restore a backup image to a client computer, where the backup image would include the operating system and any other data, settings, applications, or any other kinds of files or information that had been on the client computer at the time the backup image was made. This would be useful, for example, in the event of a virus infection, or a hard drive failure.

A server computer 210 has a restore OS and application 400, as well as three sets of backup files, 402, 404, and 406 disposed on a mass storage device 202. Restore OS and application 400 could consist of an operating system that is bootable over a network and an application that would allow the restoration of backup files. First client computer 208 has a mass storage system 410, which contains an operating system, application, and data files. Because of a problem with the mass storage device, a user on computer 208 may desire to restore the computer by obtaining the first client backup image 402 from server 210 by performing first restore operation 320. Initializing first client computer 208 via a network boot to load restore OS and application 400 may allow the user to invoke the restore application to restore a backup 402. This may cause the operating system, application, and data files on computer 308 to be replaced with the first client backup image 402 stored on server 210, resulting in application and data file recovery including changes made up to the time the backup image was created.

Similarly, a user at the second client computer 212 may re-initialize the local mass storage device 414 with the second client backup image 404, restoring all data and applications to the state they had been at the time the backup image was created.

A person skilled in the art may recognize that first server computer 210 may include a plurality of backup images; including multiple images for some client computers, while there may be no images for some other client computers. These backup images may be disposed on mass storage device 202. The mass storage device may include an internal hard drive, an external hard drive, CD or DVD drives, USB devices, or other external or internal computer readable media or the like. The backup and disposition of backup files may be accomplished by a process for restoring backup images. A person skilled in the art may also recognize that multiple mass storage devices may be used to hold backup images, and that some backup images may be spread across multiple mass storage devices.

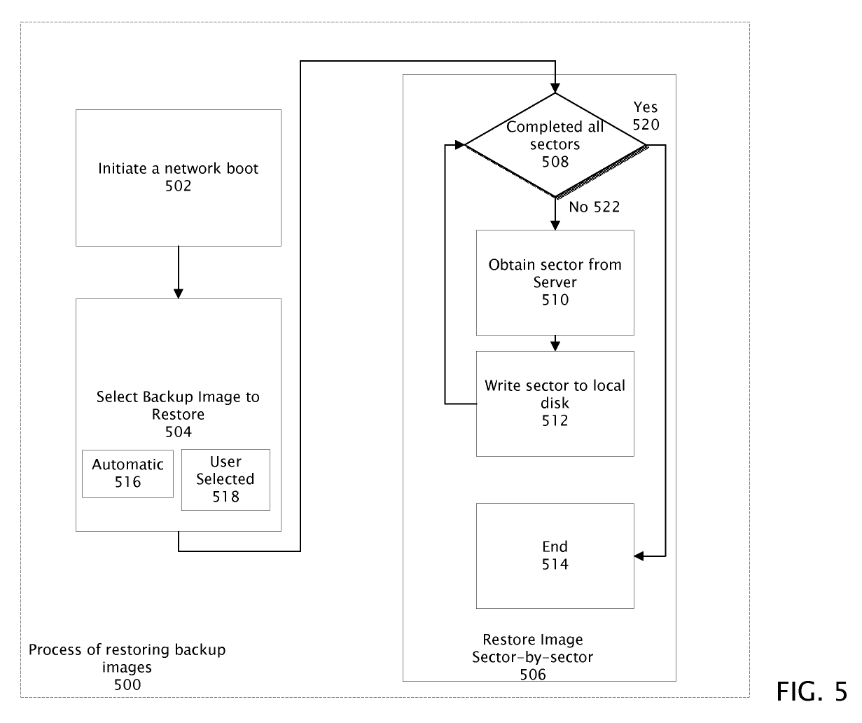

FIG. 5 is a flowchart showing a procedure for restoring backup images where the backup image to restore is either selected automatically or via a user interface. A user can initiate a network boot 502, which may connect the client to a server computer. The server computer may provide the necessary operating system files to boot the client computer. This provides an operating environment in which a backup image may be selected to restore 504. Selecting the backup image to restore may either be provided through an automated process 516, or user selected 518.

Once the backup image to restore is selected, a process to restore the image sector-by-sector may be performed 506. The process 506 includes obtaining a sector from the server 510, and writing the sector to a local disk 512. Next the process checks if all sectors have been copied 508. If not 522, the client computer may obtain the next sector data from the server 510, and write that data to the local disk 512. The process may then loop back to check if all sectors are completed. Once all sectors are determined to be completed 520 the process may end 514, and the restore is typically complete. The process described above may be initiated by an automatic process, by a process using a user interface, or an equivalent method.

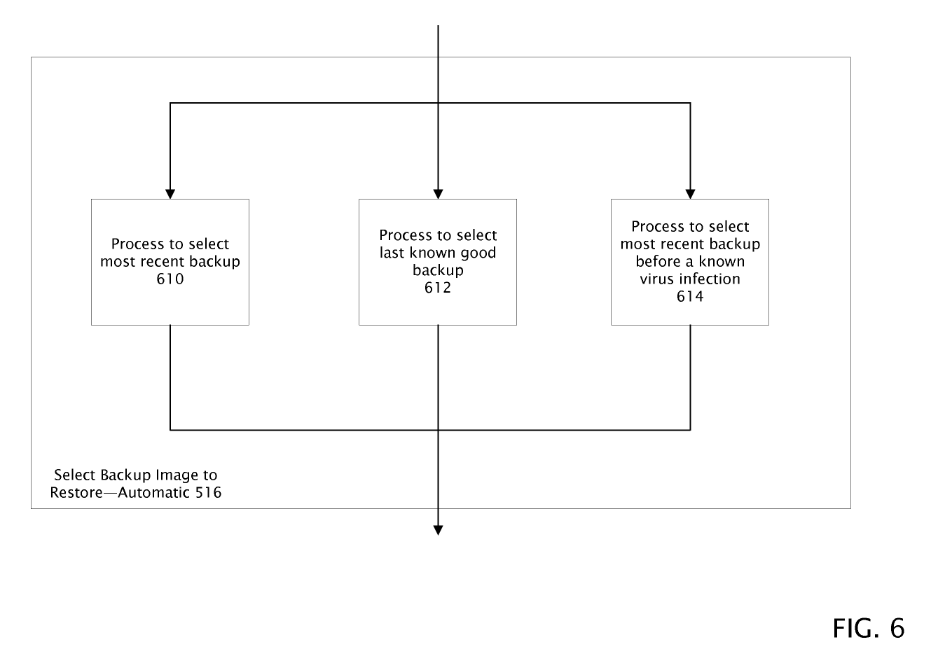

FIG. 6 is a flowchart showing a process for selecting a backup image to restore automatically 516. One skilled in the art may recognize that the automatic selection could be done in a number of ways, including choosing the most recent backup available 610, the last known good backup 612, the latest backup prior to a date that a virus was known to hit the system, or the like.

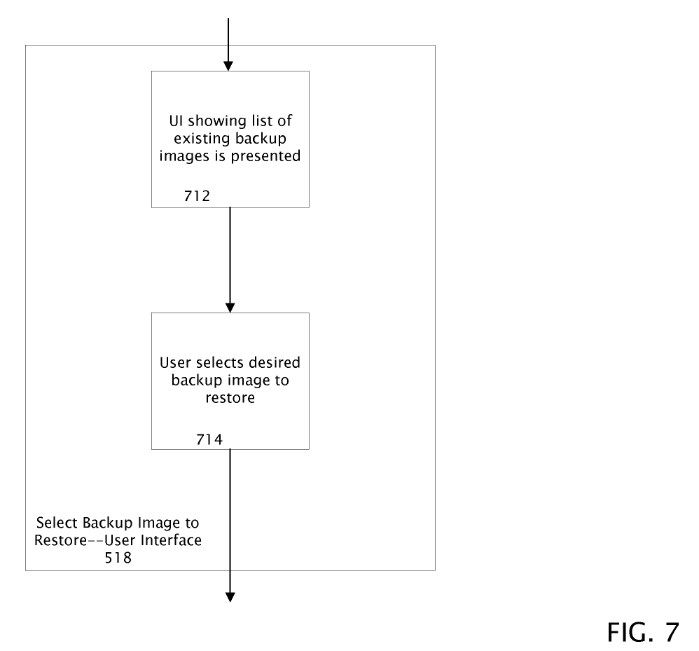

FIG. 7 is a flowchart showing a process of choosing a backup image to restore via a user interface 518. In this example, a list of possible backup images could be displayed to the user of the client computer 712, who could then select the desired backup image to restore 714. The process described above may be implemented in the computing environment described below.

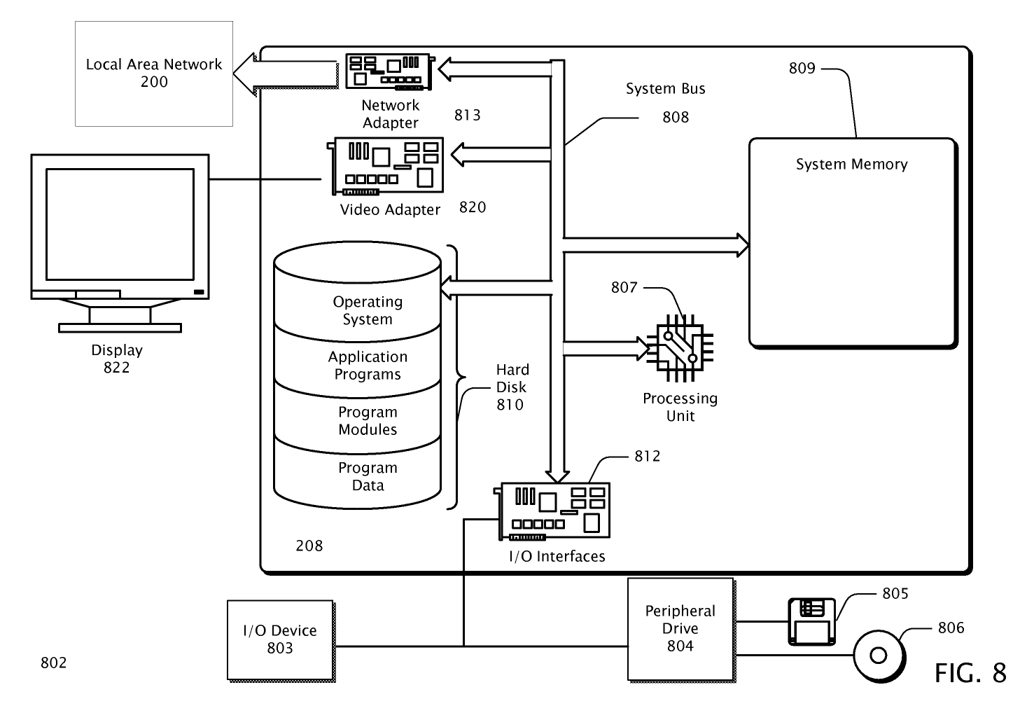

FIG. 8 illustrates an exemplary computing environment 802 in which the process of restoring a backup image from a network boot may be implemented. The computing environment 802 may be utilized with the server computer (210 of FIG. 2) or with the client computer (208, 212, or 216 of FIG. 2) of the local area network with restore information (200 of FIG. 2). Exemplary computing environment 802 is only one example of a computing system and is not intended to limit the examples described in this application to this particular computing environment.

For example the computing environment 802 can be implemented with numerous other general purpose or special purpose computing system configurations. Examples of well known computing systems, may include, but are not limited to, personal computers, hand-held or laptop devices, microprocessor-based systems, multiprocessor systems, set top boxes, gaming consoles, consumer electronics, cellular telephones, PDAs, and the like.

The computer 802 includes a general-purpose computing system in the form of a computing device 208, display 822, I/O device 803, and peripheral drive 804. The components of computing device 208 can include one or more processors (including CPUs, GPUs, microprocessors and the like) 807, a system memory 809, and a system bus 808 that couples the various system components. Processor 807 processes various computer executable instructions, including those to control the operation of computing device 208 and to communicate with other electronic and computing devices (not shown). The system bus 808 represents any number of several types of bus structures, including a memory bus or memory controller, a peripheral bus, an accelerated graphics port, and a processor or local bus using any of a variety of bus architectures.

The system memory 809 includes computer-readable media in the form of volatile memory, such as random access memory (RAM), and/or non-volatile memory, such as read only memory (ROM). A basic input/output system (BIOS) is stored in ROM. RAM typically contains data and/or program modules that are immediately accessible to and/or presently operated on by one or more of the processors 807.

Computing device 802 may include other removable/non removable, volatile/non-volatile computer storage media. By way of example, a hard disk drive 810 reads from and writes to a non-removable, non-volatile magnetic media (not shown). Such a hard disk 810 may include a magnetic disk drive which reads from and writes to a removable, non volatile magnetic disk (e.g., a “floppy disk”) 805, or an optical disk drive that reads from and/or writes to a removable, non-volatile optical disk such as a CD ROM or the like. In this example, the hard disk drive 810, and disk drive 804 are each connected to the system bus 808 by one or more data media interfaces 812. The disk drives and associated computer readable media provide non volatile storage of computer readable instructions, data structures, program modules, and other data for computing device 702.

Mass storage devices (or peripheral drive) 804 may be coupled to the computing device or incorporated into the computing device by coupling to the bus 808. Such peripheral drive 804 may include a magnetic disk drive which reads from and writes to a removable, non volatile magnetic disk (e.g., a “floppy disk”) 805, or an optical disk drive that reads from and/or writes to a removable, non-volatile optical disk such as a CD ROM or the like 806. This mass storage device may be representative of those storing the image or those being backed up. In the example described above the plurality of backups and process for restoring backups (202 of FIG. 2), restore OS (204 of FIG. 2) may be disposed on the hard disk 810 or the system memory 809. Computer readable media (“CRM”) 805, 806 typically embody computer readable instructions, data structures, program modules and the like supplied on floppy disks, CDs, portable memory sticks and the like. Such CRM may be used to produce an initialization disk.

Any number of program modules or processes can be stored on the hard disk 810, or peripheral drive 804, including by way of example, backup files, an operating system, one or more application programs, other program modules, and program data. Each of such operating system, application programs, other program modules and program data (or some combination thereof) may include an embodiment of the systems and methods described herein.

A display device 822 can be connected to the system bus 808 via an interface, such as a video adapter 820. A user can interface with computing device 208 via any number of different input devices 803 such as a keyboard, pointing device, joystick, game pad, serial port, and/or the like. These and other input devices are connected to the processors 807 via input/output interfaces 812 that are coupled to the system bus 808, but may be connected by other interface and bus structures, such as a parallel port, game port, and/or a universal serial bus (USB).

Computing device 802 can operate in a networked environment using connections to one or more remote computers through one or more local area networks (LANs), wide area networks (WANs) and the like. The computing device 208 is connected to a network 200 via a network adapter 813 or alternatively by a modem, DSL, ISDN interface or the like.

1. A method of restoring information, comprising:
initializing a computer from a networked device;
selecting a backup image that includes user generated information, disposed on the networked device; and
installing the backup image from the networked device to the computer.

2. The method of claim 1 in which the networked device is a network file share.

3. The method of claim 1 in which the networked device is a server.

4. The method in claim 1 in which the backup image is a copy of a mass storage device of the computer.

5. The method in claim 1 in which the user generated information is a backup copy of machine-specific information.

6. The method in claim 1 in which the backup image that includes user generated information is disposed on a second networked device.

7. The method in claim 1 in which selection of the backup image is achieved through user interaction.

8. The method in claim 1 in which selection of the backup image is achieved through an automated process

9. A method of restoring information, comprising:
initializing a computer from a networked device by activating a “boot from network” procedure to restore information including user generated information;
selecting a remotely stored backup image that includes user generated information to restore; and
installing the remotely stored backup image to the computer.

10. The method of claim 9 in which the networked device is a network file share.

11. The method of claim 9 in which the networked device is a server.

12. The method in claim 9 in which the backup image is a copy of a mass storage device of the computer.

13. The method in claim 9 in which the backup image that includes user generated information is disposed on the networked device.

14. The method in claim 9 in which the user generated information is a backup copy of machine-specific information.

15. The method in claim 9 in which selection of the backup image is achieved through a user interface.

16. The method in claim 9 in which selection of the backup image is achieved through an automated process

17. One or more computer-readable media having executable instructions stored thereon, comprising:
initializing a computer from a networked device;
selecting a backup image that includes user generated information, from the networked device;
retrieving the backup image from the networked device to the computer; and
installing the backup image on the computer.

18. The computer-readable media of claim 17 in which the selection of the backup image is achieved through a user interface.

19. The computer-readable media of claim 17 in which the backup image is a copy of a mass storage device of the computer.

20. The computer-readable media of claim 17 in which the networked device is a network file share.
